(19) United States
(12) Patent Application Publication
(10) Pub. No.: US 2019/0333422 A1
(43) Pub. Date: Oct. 31, 2019

(54) Recreational Vehicle Safety Alert System

(71) Applicants: Lenora Proft Sumsky, Manchester, CT (US); Melanie Cohen Scheibenpflug, Manchester, CT (US)

(72) Inventors: Lenora Proft Sumsky, Manchester, CT (US); Melanie Cohen Scheibenpflug, Manchester, CT (US)

(21) Appl. No.: 16/392,456

(22) Filed: Apr. 23, 2019

Related U.S. Application Data
(60) Provisional application No. 62/662,829, filed on Apr. 26, 2018.

(51) Int. Cl. G09F 7/02; G09F 21/04; G09F 7/18

(52) U.S. Cl. CPC G09F 7/02; G09F 21/048; G09F 2007/1886; G09F 2007/1865; G09F 7/18

(57) ABSTRACT

This disclosure relates generally to towing signs and, more specifically, to signs regarding vehicles in tow.

Apparatus that affixes to towed vehicles or equipment that is mounted to the vehicle which alerts other drivers to the potential hazard inherent in vehicle towing situations. The apparatus is comprised of a mesh material, encased wire border, durable and flexible strapping, and reflective or contrasting characters.

### CROSS-REFERENCE TO RELATED APPLICATIONS

Not Applicable

### STATEMENT REGARDING FEDERALY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Motor homes and other types of vehicles frequently tow automobiles, trailers, and recreational equipment carriers, such as those used to transport bicycles, jet skis, wheelchairs, or snow mobiles. The total length of the towing vehicle combined with the length of towed vehicle and equipment can exceed 55 feet. This makes maneuvering more difficult and increases the amount of time needed to stop safely.

In addition, and more importantly, other drivers that do not realize that a vehicle is being towed may attempt to cut in, or turn too soon, causing a hazardous situation or a collision.

Because a towed vehicle acts and reacts the same as the towing vehicle, it is beneficial for other drivers to recognize that they are following or attempting to pass a vehicle in tow.

Vehicles that tow automobiles, trailers, and/or other equipment frequently travel at speed slower than surrounding traffic, which can potentially create stress and frustration for other drivers.

The Recreational Vehicle Safety Alert System warns other drivers that a vehicle is being towed, which avoids an unexpected hazardous situation. This simple, friendly, and informative message helps reduce frustration for other drivers.

A report by the Federal Motor Carrier Safety Administration in 2012, indicated that more than 75,000 people were injured in RV accidents with some of the accidents being described as catastrophic.

Landscapers, equipment haulers, contractors and others who tow machines and equipment face similar issues.

The unique mesh sign surface and the hook and loop attachment system of the Recreational Vehicle Safety Alert System provides flexibility to safely attach the sign to a wide variety of surfaces and objects. In addition, the sign will stay tightly affixed at towing speeds of more than 65 miles per hour.

Other towing warning signs (Pat. No. 9,840,189) use a solid (non-porous) surface which unless affixed to a flat surface, creates wind resistance that can cause the sign to dislodge and create an even more dangerous hazard. In addition, non-porous signs can collect water or other precipitation, which adds weight to the overall sign and can splash and potentially drench an individual when detaching the sign.

Some towing warning signs (Pat. No. 9,840,189) are attached using heavy plastic or metal hooks, loops, or buckles. These can harm painted surfaces, damage the sign, or create dangerous projectiles.

Warning sign systems (Pat. No. 4,667,478) that attach to the top of the towed or towing vehicle can be difficult for one person to install without the use of a ladder. In addition, this style of warning sign increases the overall height of the vehicle. Excessive height can create clearance issues when traveling beneath certain structures, such as bridges or overpasses.

Similarly, signs that protrude both above and from the side of the vehicle (Pat. No. 4,609,133) can also create clearance problems by unnecessarily increasing the overall size of the towing vehicle.

The Recreational Vehicle Safety Alert System is easily installed on the back of the towed vehicle or carried equipment without a ladder, by only one person of average height.

Some signs that require a more permanent attachment mechanism, lack flexibility which is extremely important as towing needs and conditions change.

The Recreational Vehicle Safety Alert System is designed to fit almost any vehicle, regardless of vehicle make or model.

Other warning signs require folding or rolling for storage. The Recreational Vehicle Safety Alert System sign is designed to be stored flat with a thickness of less than one inch or collapsed into an area that is less than one foot in diameter and two inches thick. The Recreational Vehicle Safety Alert System sign weighs less than one pound.

### BRIEF SUMMARY OF THE INVENTION

A safety sign that attaches to a towed vehicle that identifies potential hazard of towed vehicle.

The sign is constructed of a mesh surface, affixed to a flexible oval shaped metal wire which is encased in a weather resistant material. The safety sign has four hook and loop straps that are securely attached to the weather resistant material. These hook and loop straps are used to attach the sign to the towed vehicle, or equipment that is mounted to the vehicle.

The message that alerts other drivers to the towing situation is displayed using high contrast and/or reflective characters.

### BRIEF DESCRIPTION OF THE SEVERAL VIEWS OF THE DRAWING

FIG. 1 Recreational Vehicle Safety Alert System Basic Design:

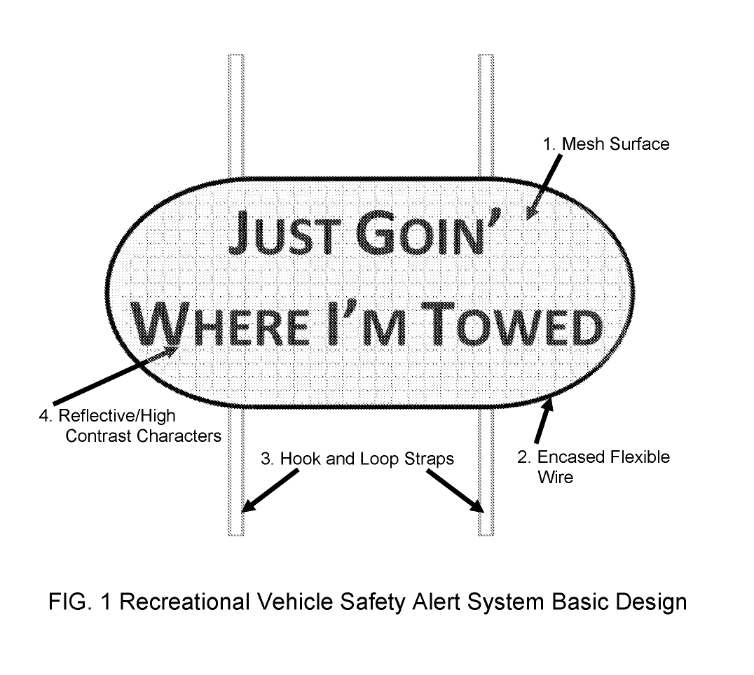

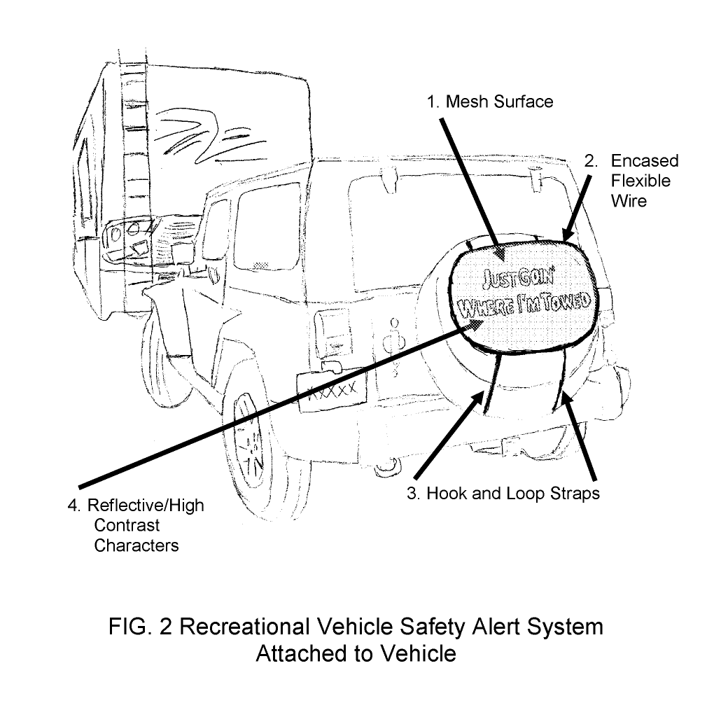

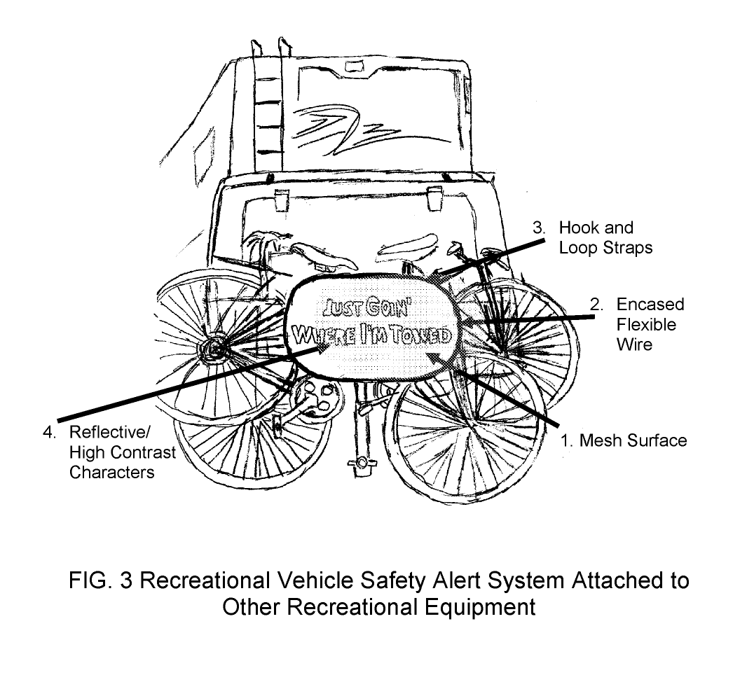

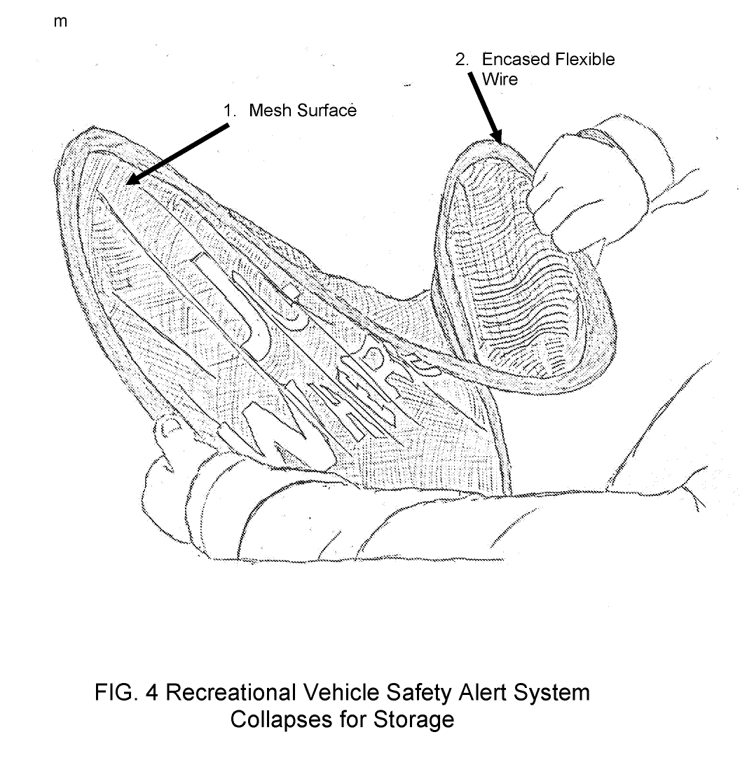

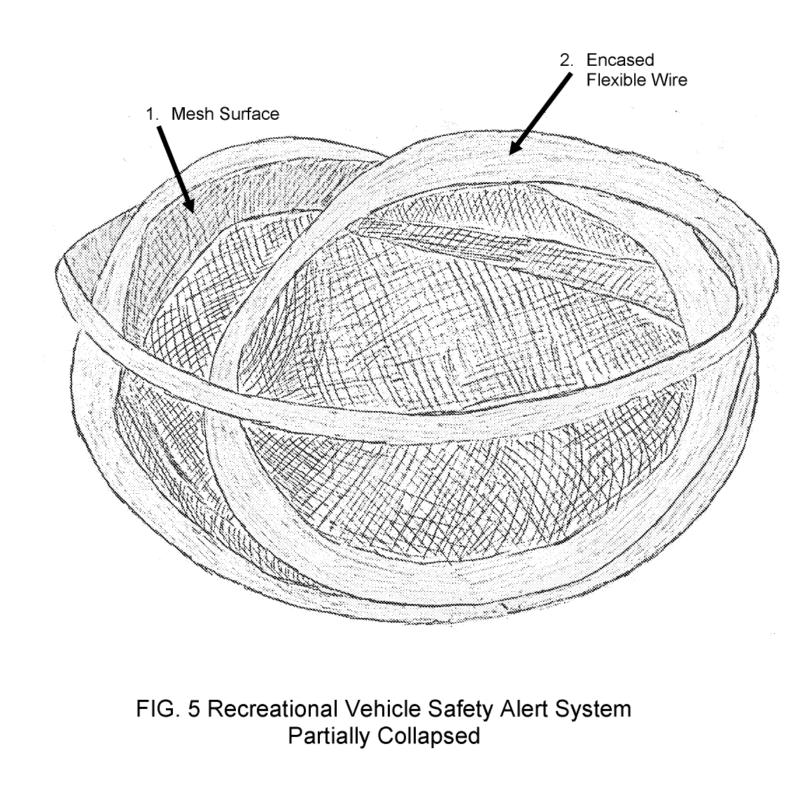

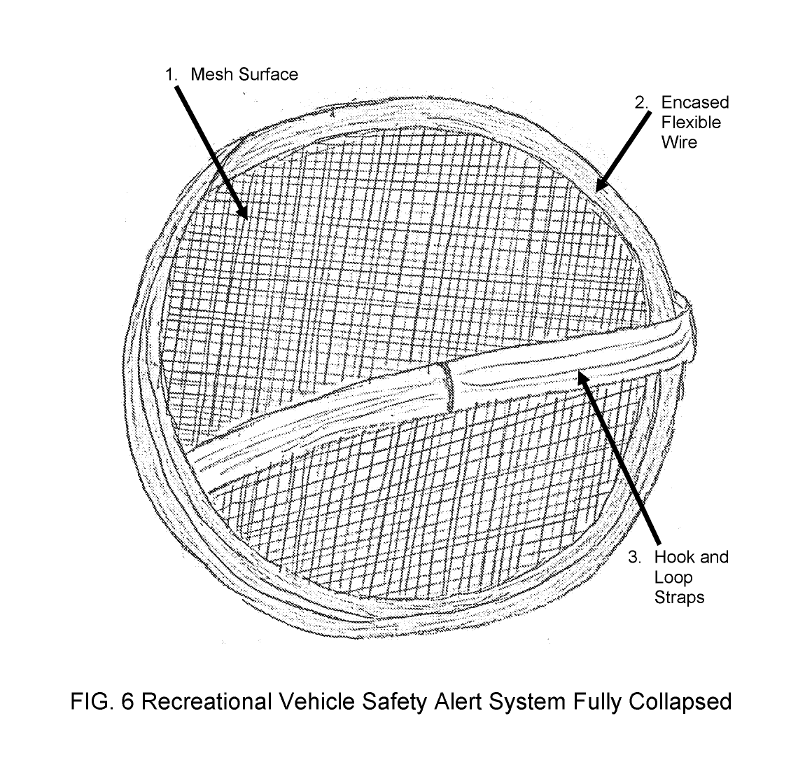

The Mesh Surface (1) ensures stability when traveling at highway speeds allowing air and rain water to pass through without causing a sail or billowing effect of the safety sign.

The Encased Flexible Wire (2), which consists of flexible, bendable wire wrapped in weather and sun resistant material, helps to eliminate or reduce scratching of surfaces.

The Hook and Loop Straps (3) provide flexibility to attach the safety sign to a variety of surfaces or equipment, such as a spare tire, certain rear windows, bicycles, or other equipment of various sizes and shapes.

The Reflective/High Contrast Characters (4) of the sign's message, alert other drivers to the towing situation.

FIG. 2 Recreational Vehicle Safety Alert System Attached to Vehicle:

This illustrates one of several options for attaching the safety sign to an external rear mounted spare tire using the Hook and Loop Straps (3). In this situation, the straps securely fasten behind the tire. The straps are long enough to fit most tire sizes.

The Reflective/High Contrast Characters (4) are visible against a tire or tire cover.

The sign's Mesh Surface (1) allows rain water to pass through and thereby avoid a buildup of water between the sign and the tire.

The Encased Flexible Wire (2) reduces rubbing and friction which can harm painted surfaces or wear fabric, such as tire covers.

FIG. 3 Recreational Vehicle Safety Alert System Attached to Other Recreational Equipment:

This figure illustrates one of several options for attaching the safety sign to bicycles or other equipment using the Hook and Loop Straps (3). In this situation, the straps easily fasten to the bicycle frame or other items/equipment mounted to or being carried on the towed vehicle.

The Reflective/High Contrast Characters (4) are easily visible against the bicycle or other equipment.

The Mesh Surface (1) allows rain water to pass through which prevents buildup between the sign and the equipment.

The Encased Flexible Wire (2) reduces rubbing and friction of affixed equipment and is flexible enough to fit a wide variety of equipment.

FIG. 4 Recreational Vehicle Safety Alert System Collapses for Storage

This illustration shows the sign collapsing for storage. By firmly holding the opposing shorter ends of the sign and twisting, the sign will collapse into a disc shape for storage.

The Encased Flexible Wire (2) is easily twisted, and the Mesh Surface (1) is flexible which allows the sign to collapse.

FIG. 5 Recreational Vehicle Safety Alert System Partially Collapsed

This diagram shows the sign reshaped for storage. The Mesh Surface (1) is held neatly in place by the twisted Encased Flexible Wire (2).

FIG. 6 Recreational Vehicle Safety Alert System Fully Collapsed

This figure shows the sign collapsed for storage. When fully collapsed, the sign forms a disc shape approximately twelve inches in diameter with a thickness of two inches. The Mesh Surface (1) is held neatly in place by the Encased Flexible Wire (2). The Hook and Loop Straps (3) fasten together to keep the shape secured during storage.

### DETAILED DESCRIPTION OF THE INVENTION

The Recreational Vehicle Safety Alert System is uniquely constructed for flexibility, durability and effectiveness. It is comprised of a mesh surface, sturdy yet flexible, wire encased in weather resistant heavy-duty material, four hook and loop straps, and message in high contract or reflective characters.

The mesh surface is cut to an oval shape of approximately 18 to 30 inches. The weather resistant material is machine stitched to the edges of the mesh surface forming a casing which holds the sturdy flexible wire.

The weather resistant material that forms the casing also creates a border to which four hook and loop straps are anchored. The hook and loop straps are machine stitched to the casing border with heavy duty weather resistant thread. These straps are used to attach the sign to a wide variety of objects or surfaces.

The sturdy flexible wire is inserted into the casing. The ends of the wire are held together with a tape-like adhesive sheet. The casing is sealed with heavy duty weather resistant thread.

Once assembled, the encased wire forms a frame that holds the mesh surface taut.

The characters and images of the message are attached to the mesh surface with heat fusion or stenciled onto the mesh surface using highly reflective paint medium.

The construction of the Recreational Vehicle Safety Alert System is designed to fit almost any vehicle, regardless of vehicle make or model. The structure and composition allow for collapsing of the sign for convenient storage. The sign can also be stored flat.

The total weight of the materials used in the construction of this sign is less than one pound which makes it easy for one person to affix the sign to the towed vehicle or equipment.

1. A safety alert sign comprising:
an oblong shaped mesh surface;
an encased flexible wire that is affixed to the edges of mesh surface;
four hook and loops straps that are attached to the encased wire edging of the sign; and
a warning message in reflective or high contrast characters.
